(19) United States
(12) Patent Application Publication
(10) Pub. No.: US 2025/0061325 A1
(43) Pub. Date: Feb. 20, 2025

(54) SYSTEMS AND METHODS FOR GENERATING MACHINE LEARNING MODELS BASED ON PANEL DATA SPLIT ALONG CROSS-SECTIONAL AND TIME DIMENSIONS

(71) Applicant: Capital One Services, LLC, McLean, VA (US)

(72) Inventors: Rongwen WU, McLean, VA (US); Parmanand SAHU, McLean, VA (US); Chandramouli BANERJEE, McLean, VA (US); Yigit ALTINTAS, McLean, VA (US); Hongfei DU, McLean, VA (US)

(73) Assignee: Capital One Services, LLC, McLean, VA (US)

(21) Appl. No.: 18/449,671

(22) Filed: Aug. 14, 2023

(51) Int. Cl. G06N 3/08; G06N 3/045

(52) U.S. Cl. CPC G06N 3/08; G06N 3/045

(57) ABSTRACT

Systems and methods for generating machine learning models based on panel data split along cross-sectional and time dimensions. The system may split panel data into a train, test, and validation dataset. The system may determine, based on the validation dataset, an out-of-time period and remove, data falling within the out-of-time period. Then, the system may remove, from the train dataset, data falling within the out-of-time period. The system may determine, based on the validation dataset, one or more time intervals and remove, data falling outside of the one or more time intervals. The validation dataset includes out-of-sample and out-of-time data with respect to the train dataset. The system may remove, from the train dataset, data falling within the one or more time intervals. The system may train a first machine learning model based on the train dataset, select model based on validation dataset, and test model performance on test dataset.

### SUMMARY

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations.

In one example, machine learning models using panel data are widely used for tracking how things change over time such as tracking the evolution of a social network. Developing a machine learning model on panel data poses a lot of challenges due to limited observations along the time dimension. In building ML models, data needs to be split into training, validation, and test samples. The system may train many models on training data, select a model that performs well on the validation data, and then use the test data to confirm model performance. Because panel data contains a time dimension, it can be difficult to effectively train models on panel data. For example, currently, machine learning models trained on panel data can be vulnerable to bias. This is due to the data being influenced by trends or cyclical patterns over time. These technical problems present an inherent problem with attempting to use an artificial intelligence-based solution in effectively training machine learning models on panel data.

Methods and systems are described herein for novel uses and/or improvements to artificial intelligence applications. As one example, methods and systems are described herein for generating better-performing machine learning models with more accurate results for panel data as compared to existing systems.

Existing systems fail to have training and validation datasets that contain information that is complementary to one another. For example, existing systems may contain an out-of-time test dataset to assess the model performance for a determined out-of-time period (e.g., held-out temporal data from the training and validation datasets) by holding back some time periods from training and validation datasets. However, the issue with this approach is that this selection process does not consider out-of-time performance with respect to the train dataset as the validation sample does not contain out-of-time data with respect to the train dataset.

To overcome these technical deficiencies in adapting artificial intelligence models for this practical benefit, methods, and systems disclosed herein determine, based on the validation dataset, one or more time intervals and remove, from the validation dataset, data falling outside of the one or more time intervals, wherein the validation dataset includes data that is out-of-sample and out-of-time with respect to the train dataset. By ensuring the validation data contain both out-of-sample and out-of-time observations, the system may generate the best-performing machine learning model that can perform well in different forecasting scenarios. To produce data splits for ML models using data with a time dimension, the system ensures that it contains information that is complementary to the training set both along the cross-sectional dimension (out-of-sample) and time dimension (out-of-time) and has sufficient testing coverage along the time dimension. Accordingly, the methods and systems provide better-performing machine learning models with more accurate results for panel data.

In some aspects, the system may split received panel data into a train dataset, a test dataset, and a validation dataset. The system may determine, based on the validation dataset, an out-of-time period and remove, from the validation dataset, data falling within the out-of-time period. Then, the system may remove, from the train dataset, data falling within the out-of-time period. The system may determine, based on the validation dataset, one or more time intervals and remove, from the validation dataset, data falling outside of the one or more time intervals. At this point validation dataset includes data that is out-of-sample and out-of-time with respect to the train dataset. Then the system may remove, from the train dataset, data falling within the one or more time intervals, following which the train dataset includes data that is out-of-sample and out-of-time with respect to the validation dataset. The system may train a first machine learning model based on the train dataset and the validation dataset, and perform tests on the test dataset.

The system may split received panel data. In particular, the system may split received panel data into a train dataset, a test dataset, and a validation dataset. For example, the system may receive panel data that contains 100 individuals observed over 10 years. The system may randomly split the data into a train dataset, a test dataset, and a validation dataset. For example, the train dataset contains 70 individuals, the validation dataset contains 10 individuals, and the test dataset contains 20 individuals.

The system may determine an out-of-time period. In particular, the system may determine, based on the validation dataset, an out-of-time period and remove, from the validation dataset, data falling within the out-of-time period. For example, the system may determine an out-of-time period which is data after the first 8 years in the panel data and remove the last 2 years from the validation dataset. By doing so, the system is determining an in-time test and out-of-time test period for the test dataset.

The system may remove data from the train dataset. In particular, the system may remove, from the train dataset, data falling within the out-of-time period. For example, the system may remove the last 2 years from the train dataset. By doing so, the system is determining an in-time test and out-of-time test period for the test dataset.

The system may determine one or more time intervals. In particular, the system may determine, based on the validation dataset, one or more time intervals and remove, from the validation dataset, data falling outside of the one or more time intervals. The validation dataset includes data that is out-of-sample and out-of-time with respect to the train dataset. For example, the system may select years 2, 4, 6, and 8 from the validation dataset and remove years 1, 3, 5, and 7 from the validation dataset.

The system may remove data from the train dataset. In particular, the system may remove, from the train dataset, data falling within the one or more time intervals. The train dataset includes data that is out-of-sample and out-of-time with respect to the validation dataset. For example, if the system selects years 2, 4, 6, and 8 from the validation dataset, the system will remove years 2, 4, 6, and 8 from the train dataset. Therefore, the train dataset and validation dataset are complementary to one another.

The system may train a first machine learning model. In particular, the system may train a first machine learning model based on the train dataset and the validation dataset and perform tests on test dataset. For example, the system may train a machine learning model using the train dataset, evaluate the performance of the particular model using the validation dataset and upon training multiple such models, select the most performant one. Finally, the system may test the machine learning model on new unseen data contained within the test dataset.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for generating machine learning models based on panel data that is split along cross-sectional and time dimensions, in accordance with one or more embodiments.

FIGS. 2A-2B shows an illustrative diagram for splitting, based on a variable, the panel data into a train dataset, a test dataset, and a validation dataset, in accordance with one or more embodiments.

FIG. 3 shows illustrative components for a system used to generate machine learning models based on panel data, in accordance with one or more embodiments.

FIG. 4 shows a process for splitting, based on the variable, the panel data into a train dataset, a test dataset, and a validation dataset, in accordance with one or more embodiments.

FIG. 5 shows a flowchart of the steps involved in generating machine learning models based on panel data, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

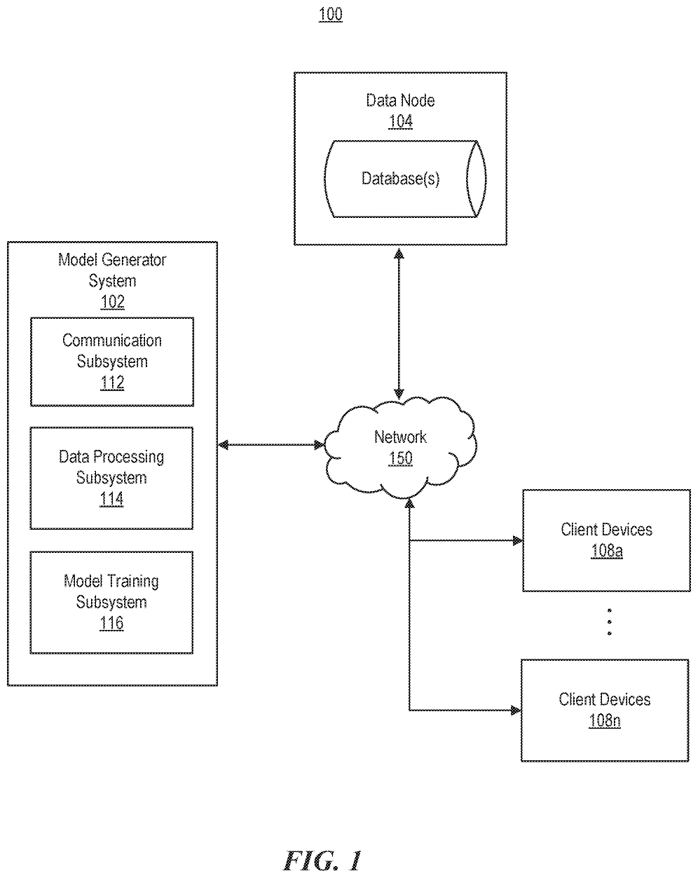

FIG. 1 shows an illustrative diagram for a system for generating machine learning models based on panel data that is split along cross-sectional and time dimensions, in accordance with one or more embodiments. Environment 100 includes model generator system 102, data node 104, and client devices 108a-108n.

Model generator system 102 may include software, hardware, or a combination of both and may reside on a physical server or a virtual server running on a physical computer system. In some embodiments, model generator system 102 may be configured on a user device (e.g., a laptop computer, a smartphone, a desktop computer, an electronic tablet, or another suitable user device). Furthermore, model generator system 102 may reside on a cloud-based system and/or interface with computer models either directly or indirectly, for example, through network 150. Model generator system 102 may include communication subsystem 112, data processing subsystem 114, and/or model training subsystem 116.

Data node 104 may store various data, including one or more machine learning models, training data, user data profiles, input data, output data, performance data, and/or other suitable data. Data node 104 may include software, hardware, or a combination of the two. In some embodiments, model generator system 102 and data node 104 may reside on the same hardware and/or the same virtual server or computing device. Network 150 may be a local area network, a wide area network (e.g., the Internet), or a combination of the two.

Client devices 108a-108n may include software, hardware, or a combination of the two. For example, each client device may include software executed on the device or may include hardware, such as a physical device. Client devices may include user devices (e.g., a laptop computer, a smartphone, a desktop computer, an electronic tablet, or another suitable user device).

Model generator system 102 may receive user responses from one or more client devices. Model generator system 102 may receive data using communication subsystem 112, which may include software components, hardware components, or a combination of both. For example, communication subsystem 112 may include a network card (e.g., a wireless network card and/or a wired network card) that is associated with software to drive the card and enables communication with network 150. In some embodiments, communication subsystem 112 may also receive data from and/or communicate with data node 104 or another computing device. Communication subsystem 112 may receive data, such as input data, user responses, or user preferences. Communication subsystem 112 may communicate with data processing subsystem 114 and model training subsystem 116.

Model generator system 102 may include data processing subsystem 114. Communication subsystem 112 may pass at least a portion of the data or a pointer to the data in memory to data processing subsystem 114. Data processing subsystem 114 may include software components, hardware components, or a combination of both. For example, data processing subsystem 114 may include software components or may include one or more hardware components (e.g., processors) that are able to execute operations for processing panel data. Data processing subsystem 114 may access panel data. Data processing subsystem 114 may directly access data or nodes associated with client devices 108a-108n and may transmit data to these client devices. In some embodiments, data processing subsystem 114 may process datasets to generate updated datasets. Data processing subsystem 114 may, additionally or alternatively, receive data from and/or send data to communication subsystem 112 and model training subsystem 116.

Model training subsystem 116 may execute tasks relating to training a machine learning model. Model training subsystem 116 may include software components, hardware components, or a combination of both. For example, model training subsystem 116 may train a machine learning model on panel data. Model training subsystem 116 may access data, such as datasets for training, testing, and validation. Model training subsystem 116 may directly access data or nodes associated with these datasets. Model training subsystem 116 may also receive input data, as well as data output by client devices 108a-108n. Model training subsystem 116 may allow model generator system 102 to improve model generation, in accordance with one or more embodiments. Model training subsystem 116 may, additionally or alternatively, receive data from and/or send data to communication subsystem 112 or data processing subsystem 114.

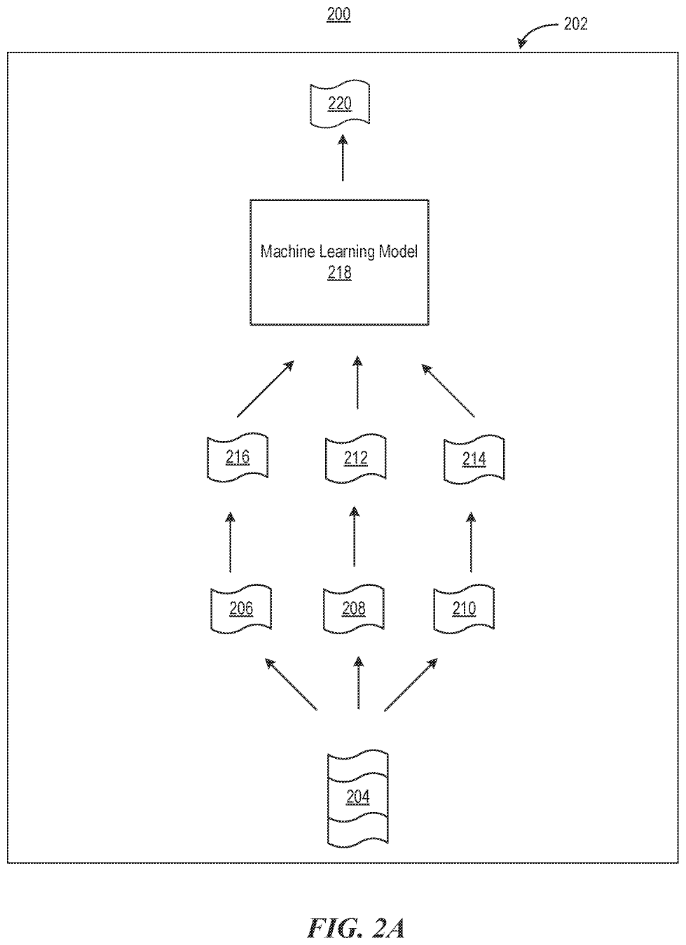

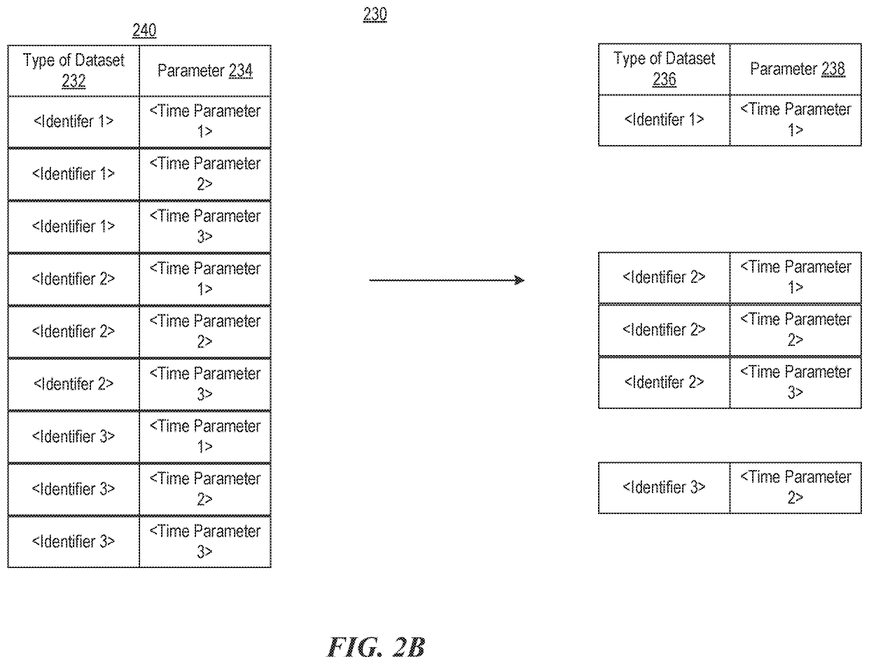

FIG. 2A-FIG. 2B show an illustrative diagram for splitting, based on the variable, the panel data into a train dataset, a test dataset, and a validation dataset, in accordance with one or more embodiments. FIG. 2A shows environment 200. Environment 200 includes server 202, panel data 204, train dataset 206, validation dataset 208, test dataset 210, train dataset 216, validation dataset 212, test dataset 214, machine learning model 218, and output 220.

In some embodiments, server 202 may remove instances of incomplete data. In particular, prior to splitting the panel data (e.g., panel data 204) into a train dataset (e.g., train dataset 206), a test dataset (e.g., test dataset 210), and a validation dataset (e.g., validation dataset 208) server 202 may preprocess the panel data (e.g., panel data 204) to remove any instances of incomplete data.

Server 202 may split received panel data (e.g., panel data 204). In particular, server 202 may split received panel data (e.g., panel data 204) into a train dataset (e.g., train dataset 206), a test dataset (e.g., test dataset 210), and a validation dataset (e.g., validation dataset 208). For example, the split panel data 204 is described further herein with reference to FIG. 2B. FIG. 2B illustrates process 230. Process 230 includes an exemplary table 240 which includes dataset identifier 232, and parameter 234. Process 230 additionally illustrates dataset identifier 236 and parameter 238. Dataset identifier 236 and parameter 238 are associated with dataset identifier 232 and parameter 234. Table 240 may represent panel data 204. The system may split the panel data 204 into a train dataset, a test dataset, and a validation dataset. As shown, there is one instance with each type of identifier for dataset identifier 232 paired with each type of time parameter with parameter 234. In table 240, identifier 1, identifier 2, and identifier 3 may refer to a train dataset, test dataset, and validation dataset. In another example, the system may receive panel data 204 that contains 100 individuals observed over 10 years. The system may randomly split the data into train dataset 206, test dataset 210, and validation dataset 208. For example, the train dataset contains 70 individuals, the validation dataset contains 10 individuals, and the test dataset contains 20 individuals. In some embodiments, server 202 may determine a size for each dataset. In particular, server 202 may determine, from received panel data (e.g., panel data 204), a variable to uniquely identify records along a cross-sectional dimension in the panel data. Server 202 may determine, based on the received panel data (e.g., panel data 204), a size for the train dataset (e.g., train dataset 206), test dataset (e.g., test dataset 210), and validation dataset (e.g., validation dataset 208). The size corresponds to a time period of the panel data.

Server 202 may determine an out-of-time period. In particular, server 202 may determine, based on the validation dataset (e.g., validation dataset 208), an out-of-time period and remove, from the validation dataset (e.g., validation dataset 208), data falling within the out-of-time period. For example, the system may determine an out-of-time period is any data after the first 8 years in the panel data 204 in a ten-year time period, and remove the last 2 years from the validation dataset 208. For example, in FIG. 2B, the system may remove time parameter 3 from parameter 238 from identifier 3 from dataset identifier 236 as an out-of-time period. By doing so, the system is able to generate validation dataset 212.

Server 202 may remove data from the train dataset (e.g., train dataset 206). In particular, server 202 may remove, from the train dataset (e.g., train dataset 206), data falling within the out-of-time period. For example, the system may remove the last 2 years from the train dataset. For example, in FIG. 2B, the system may remove time parameter 3 from parameter 238 from identifier 1 (e.g., train dataset) from dataset identifier 236 as an out-of-time period. By doing so, the system is able to generate train dataset 216.

Server 202 may determine one or more time intervals. In particular, server 202 may determine, based on the validation dataset (e.g., validation dataset 208), one or more time intervals and remove, from the validation dataset, data falling outside of the one or more time intervals. The validation dataset (e.g., validation dataset 208) includes data that is out-of-sample and out-of-time with respect to the train dataset (e.g., train dataset 206). For example, the system may select years 2, 4, 6, and 8 from the validation dataset and remove years 1, 3, 5, and 7 from the validation dataset. In another example, in FIG. 2B, the system may determine one time interval as time identifier 2 from parameter 238. The system may remove time parameter 1 from parameter 238 from identifier 3 (e.g., validation dataset) from dataset identifier 236 since it is outside of the determined time interval.

Server 202 may remove data from the train dataset (e.g., train dataset 206). In particular, server 202 may remove, from the train dataset (e.g., train dataset 206), data falling within the one or more time intervals. The train dataset includes data that is out-of-sample and out-of-time with respect to the validation dataset. For example, the system may remove years 1, 3, 5 and 7 from the train dataset. In another example, in FIG. 2B, the system may determine one time interval as time identifier 2 from parameter 238. The system may remove time parameter 2 from parameter 238 from identifier 1 (e.g., train dataset) from dataset identifier 236 since it is within the determined time interval. Therefore, the train dataset 206 and validation dataset 208 are complementary to one another.

The system may train a first machine learning model (e.g., machine learning model 218). In particular, the system may train a first machine learning model (e.g., machine learning model 218) based on the train dataset (e.g., train dataset 206), validate the first machine learning model on the validation dataset (e.g., validation dataset 208), and test the first machine learning model on the test dataset (e.g., test dataset 210). For example, the system may train a machine learning model using the train dataset, evaluate the performance of the particular model using the validation dataset and upon training multiple such models, select the most performant one. Finally, the system may test the machine learning model on new unseen data contained within the test dataset. For example, the test dataset 210 is used to generate an estimate of model error that is out-of-sample and out-of-time with respect to the validation dataset 208 and the train dataset 206.

In some embodiments, server 202 may determine a performance metric. In particular, server 202 may determine a performance metric for the first machine learning model (e.g., machine learning model 218) for the out-of-time period based on the test dataset (e.g., test dataset 210). In response to determining whether the performance metric is below a threshold, server 202 may determine an updated one or more time intervals. In some embodiments, server 202 may generate the threshold based on the performance metric of the first machine learning model on the validation dataset. The system may determine the performance metric for the validation dataset is eighty percent accurate. The system may then set the threshold value to eighty percent to ensure the machine learning model remains accurate for the out-of-time period data. If the threshold value is below eighty, server 202 may remove from the train dataset (e.g., train dataset 206) and the validation dataset (e.g., validation dataset 208) data falling within the updated one or more time intervals. For example, the system may determine a new number of time intervals and retrain the machine learning model 218. In some embodiments, in response to determining that the performance metric is below the threshold, server 202 may determine a new size for the train dataset, the test dataset, and the validation dataset. The new size corresponds to a larger time period of the panel data compared to a previous size. For example, instead of determining a size of 8 years, the system may generate a new size of 9 years from 10 years of panel data. In some embodiments, in response to determining whether the performance metric is below a threshold, server 202 may modify a set of hyperparameters of the first machine learning model (e.g., machine learning model 218). By doing so, the system may ensure the machine learning model remains accurate for future panel data.

In some embodiments, server 202 may receive new panel data. In particular, server 202 may receive new panel data and determine a new variable to uniquely identify records along a cross-sectional dimension in the new panel data. Server 202 may split, based on the new variable, the new panel data into a new train dataset, a new test dataset, and a new validation dataset. Server 202 may determine, based on the new validation dataset, an out-of-time period and remove, from the new validation dataset, data falling within the out-of-time period. Server 202 may remove, from the train dataset, data falling within the out-of-time period. Server 202 may determine, based on the new validation dataset, one or more time intervals and remove, from the new validation dataset, data falling outside of the one or more time intervals. The new validation dataset includes data that is out-of-sample and out-of-time with respect to the new train dataset. Server 202 may remove, from the new train dataset, data falling within the one or more time intervals. The new train dataset includes data that is out-of-sample and out-of-time with respect to the new validation dataset. Server 202 may train a second machine learning model based on the new train dataset. For example, the system may receive new panel data. The new panel data includes data for a new time period. In response to receiving the panel data, the system may generate a new machine learning model.

In some embodiments, server 202 may compare the first machine learning model to the second machine learning model. In particular, server 202 may compare the first machine learning model to the second machine learning model based on performance metrics to determine which machine learning model performs better. In response to determining that the second machine learning model outperforms the first machine learning model, server 202 may average outputs from the first machine learning model and the second machine learning model to generate a new output. For example, the system may utilize ensemble learning techniques. Ensemble learning techniques improve the accuracy and robustness of machine learning models by combining multiple machine learning models to improve the overall performance of the system. By averaging the predictions of two machine learning models trained on panel data, the new output achieves higher performance by using a weighted average approach. This new output is based on a larger set of panel data which may reveal new variations that both the first and the second machine learning model may not have been able to capture.

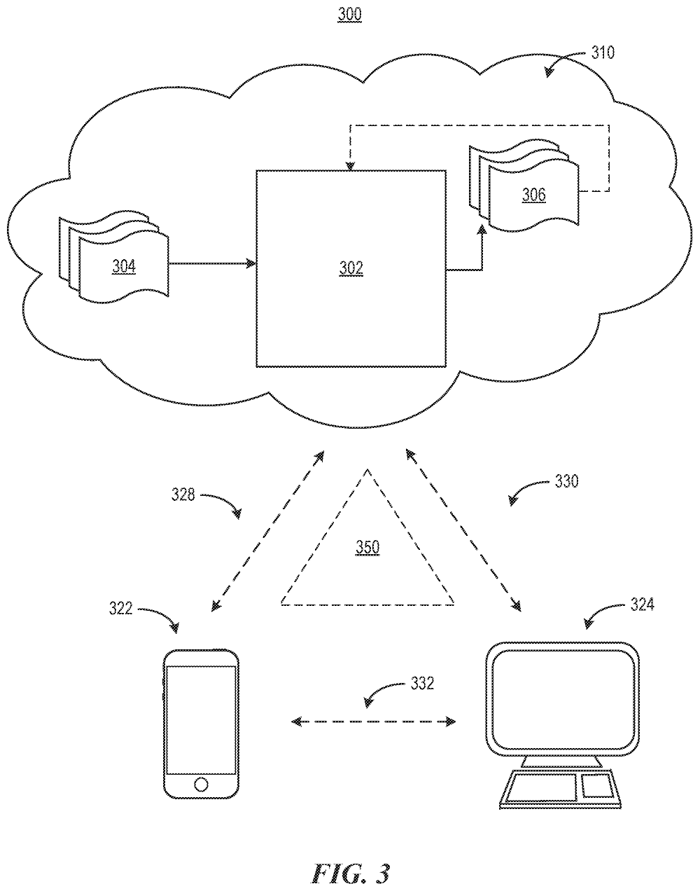

FIG. 3 shows illustrative components for a system used to generate machine learning models based on panel data, in accordance with one or more embodiments. For example, FIG. 3 may show illustrative components for generating better-performing machine learning models with more accurate results for panel data. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational responses, queries, and/or notifications).

Additionally, as mobile device 322 and user terminal 324 are shown as a touchscreen smartphone and personal computer, these displays also act as user input interfaces. It should be noted that in some embodiments, the devices may have neither user input interfaces nor display, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include model generator system 102, communication subsystem 112, data processing subsystem 114, model training subsystem 116, data node 104, client devices 108a-108n, or network 150. Cloud components 310 may access machine learning models stored on client devices 108a-108n.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., when a borrower is likely to refinance a mortgage).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The output of the model (e.g., model 302) may be used to determine risk associated with each borrower.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of the API's operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of the API layer 350 may provide integration between front-end and back-end. In such cases, API layer 350 may use RESTful APIs (exposition to the front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API platforms and their modules. API layer 350 may use a developer portal. API layer 350 may use strong security constraints applying WAF and DDOS protection, and API layer 350 may use RESTful APIs as a standard for external integration.

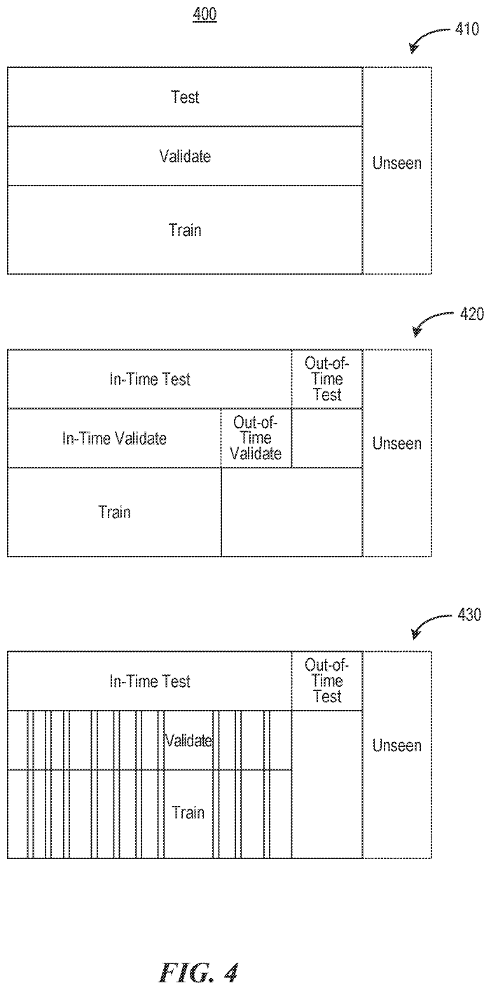

FIG. 4 shows process 400 for splitting, based on the variable, the panel data into a train dataset, a test dataset, and a validation dataset, in accordance with one or more embodiments. Process 400 includes table 410, table 420, and table 430.

First, Table 410 illustrates splitting data at random by a unique identifier. For any data with a time dimension such as panel data, the model produces forecasts on unseen data which lies in the future. For panel data, bias can be generated by variation influenced by seasonality. Therefore, it is not sufficient to evaluate the model on out-of-sample data (e.g., held-out cross-sectional data) but also out-of-time data (e.g., held-out temporal data). As such, Table 410 splits the panel data into a train dataset, validation dataset, and test dataset, while there is no out-of-time data for out-of-time performance testing.

Second, Table 420 illustrates holding back some time periods from training and validation data. This allows the system to assess model performance easily and efficiently for out-of-time data. If the system simply held out the year 2019-2021 from the training and validation data, the machine learning model may not take into account out-of-time performance as the validation sample continues to still be “in-time” (e.g., the validation sample is not distinctive in terms of temporal data). In that case, if there are hyperparameter values that impact generalizability along the time dimension, the machine learning model may lose that information. Therefore, to explicitly incorporate out-of-time information in selecting the optimal machine learning model, the system could extend the validation sample to also include an out-of-time component, as shown in table 420. This allows the system to determine a “true” out-of-time sample which provides the system with an unbiased estimate of the model error out-of-time.

However, one issue still remains. If the cross-sectional splits produce similar data distributions, the validation set doesn't provide much-added information over the training data as both cross-sectional and temporal patterns are similar. This would lead to issues such as biased performance and generating overfitted machine learning models. Therefore, table 430 illustrates determining one or more time intervals and removing, from the validation dataset, data falling outside of the one or more time intervals and removing data falling within those one or more time intervals from the train dataset. In doing so, the system ensures that the validation sample contains information complementary to what the model is going to be trained on. Therefore, the validation sample also brings out-of-time and out-of-sample information relative to the training dataset and the model parameters being selected on the basis of the performance on this sample is robust.

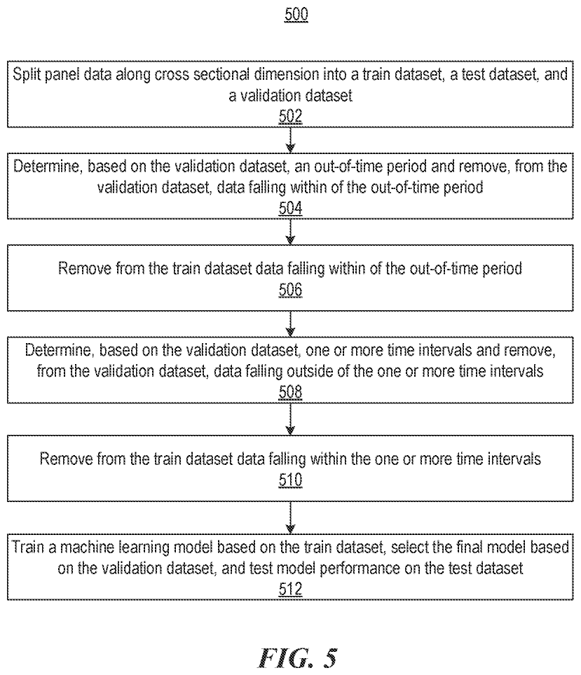

FIG. 5 shows a flowchart of the steps involved in generating machine learning models based on panel data, in accordance with one or more embodiments. For example, the system may use process 500 (e.g., as implemented on one or more system components described above) in order to generate better-performing machine learning models with more accurate results for panel data.

At operation 502, process 500 (e.g., using one or more components described above) may split received panel data along cross sectional dimension into a train dataset, a test dataset, and a validation dataset. For example, the system may split received panel data into a train dataset, a test dataset, and a validation dataset. For example, data processing subsystem 114 may split received panel data (e.g., panel data 204) into a train dataset, a test dataset, and a validation dataset (e.g., train dataset 206, validation dataset 208, and test dataset 210). By doing so, the system may determine a train dataset, validation dataset, and test dataset for a machine learning model.

In some embodiments, the system may remove incomplete data. For example, the system may prior to splitting the panel data into a train dataset, a test dataset, and a validation dataset, preprocess the panel data to remove any instances of incomplete data. For example, the data processing subsystem 114 may preprocess the panel data (e.g., panel data 204) to remove any instances of incomplete data. By doing so, the system may ensure the train dataset, validation dataset, and test dataset include only completed data instances.

In some embodiments, the system may determine a size for each dataset. For example, the system may determine, from received panel data, a variable to uniquely identify records along a cross-sectional dimension in the panel data. The system may determine, based on the received panel data, a size for the train dataset, test dataset, and validation dataset. The size corresponds to a time period of the panel data. For example, data processing subsystem 114 may determine, from received panel data (e.g., panel data 204), a variable to uniquely identify records along a cross-sectional dimension in the panel data. Then, data processing subsystem 114 may determine, based on the received panel data (e.g., panel data 204), a size for the train dataset, test dataset, and validation dataset (e.g., train dataset 206, validation dataset 208, and test dataset 210). By doing so, the system may ensure that each dataset has a sufficient amount of quality data for generating a machine learning model.

At operation 504, process 500 (e.g., using one or more components described above) may determine, based on the validation dataset, an out-of-time period and remove, from the validation dataset, data falling within the out-of-time period. For example, the system may determine, based on the validation dataset, an out-of-time period and remove, from the validation dataset, data falling within the out-of-time period. For example, data processing subsystem 114 may determine, based on the validation dataset (e.g., validation dataset 208), an out-of-time period and remove, from the validation dataset (e.g., validation dataset 208), data falling within the out-of-time period. By doing so, the system is determining an in-time test and out-of-time test period for the validation dataset.

At operation 506, process 500 (e.g., using one or more components described above) may remove from the train dataset data falling within the out-of-time period. For example, the system may remove, from the train dataset, data falling within the out-of-time period. For example, the data processing subsystem 114 may remove, from the train dataset (e.g., train dataset 206), data falling within the out-of-time period. By doing so, the system is determining an in-time test and out-of-time test period for the train dataset.

At operation 508, process 500 (e.g., using one or more components described above) may determine, based on the validation dataset, one or more time intervals and remove, from the validation dataset, data falling outside of the one or more time intervals. For example, the system may determine, based on the validation dataset, one or more time intervals and remove, from the validation dataset, data falling outside of the one or more time intervals. The validation dataset includes data that is out-of-sample and out-of-time with respect to the train dataset. For example, data processing subsystem 114 may determine, based on the validation dataset (e.g., validation dataset 208), one or more time intervals and remove, from the validation dataset (e.g., validation dataset 208), data falling outside of the one or more time intervals. The validation dataset includes data that is out-of-sample and out-of-time with respect to the train dataset. By doing so, the system is able to generate distinctive data for the validation dataset.

At operation 510, process 500 (e.g., using one or more components described above) may remove from the train dataset data falling within the one or more time intervals. For example, the system may remove, from the train dataset, data falling within the one or more time intervals. The train dataset includes data that is out-of-sample and out-of-time with respect to the validation dataset. For example, data processing subsystem 114 may remove, from the train dataset (e.g., train dataset 206), data falling within the one or more time intervals. The train dataset includes data that is out-of-sample and out-of-time with respect to the validation dataset. Therefore, the train dataset and validation dataset is complementary to one another.

At operation 512, process 500 (e.g., using one or more components described above) may train a first machine learning model based on the train dataset. For example, model training subsystem 116 may train a first machine learning model (e.g., machine learning model 218 or model 302) based on the train dataset (e.g., train dataset 216). Then, model training subsystem 116 may select the model based on performance in validation dataset (e.g., validation dataset 212) and test the model performance in test dataset (e.g., test dataset 214). By doing so, the system may train a machine learning model, select the final model based on the validation dataset, then test the machine learning model on the test dataset.

In some embodiments, the system may determine a performance metric. Model training subsystem 116 may determine a performance metric for the first machine learning model for the out-of-time period based on the test dataset. Model training subsystem 116 may in response to determining whether the performance metric is below a threshold, determine updated one or more time intervals. For example, model training subsystem 116 may generate the threshold based on the performance metric of the first machine learning model on the validation dataset. Model training subsystem 116 may remove from the train dataset (e.g., train dataset 206) and the validation dataset (e.g., validation dataset 208) falling within the updated one or more time intervals. For example, the test dataset is used to generate an estimate of model error that is out-of-sample and out-of-time with respect to the validation dataset and the train dataset.

In some embodiments, the system may modify a set of hyperparameters. For example, model training subsystem 116 may determine a performance metric for the first machine learning model. In response to determining whether the performance metric is below a threshold, the model training subsystem 116 may modify a set of hyperparameters of the first machine learning model (e.g., machine learning model 218 or model 302). In some embodiments, in response to determining that the performance metric is below the threshold, model training subsystem 116 may determine a new size for the train dataset, the test dataset, and the validation dataset (e.g., train dataset 206, validation dataset 208, and test dataset 210). The new size corresponds to a larger time period of the panel data compared to a previous size.

In some embodiments, the system may receive new panel data. For example, communication subsystem 112 may receive new panel data using communication paths 328, 330, and 332. Data processing subsystem 114 may determine a new variable to uniquely identify records along a cross-sectional dimension in the new panel data. Data processing subsystem 114 may split, based on the new variable, the new panel data into a new train dataset, a new test dataset, and a new validation dataset. Data processing subsystem 114 may determine, based on the new validation dataset, an out-of-time period and remove, from the new validation dataset, data falling within the out-of-time period. Data processing subsystem 114 may remove, from the train dataset, data falling within the out-of-time period. Data processing subsystem 114 may determine, based on the new validation dataset, one or more time intervals and remove, from the new validation dataset, data falling outside of the one or more time intervals. The new validation dataset includes data that is out-of-sample and out-of-time with respect to the new train dataset. Data processing subsystem 114 may remove, from the new train dataset, data falling within the one or more time intervals. The new train dataset includes data that is out-of-sample and out-of-time with respect to the new validation dataset. Model training subsystem 116 may train a second machine learning model based on the new train dataset. By doing so, the system may generate a second machine learning model.

In some embodiments, the system may compare the first machine learning model to the second machine learning model. Model training subsystem 116 may compare the first machine learning model to the second machine learning model based on performance metrics to determine which machine learning model performs better. In response to determining that the second machine learning model outperforms the first machine learning model, model training subsystem 116 may average outputs from the first machine learning model and the second machine learning model to generate a new output.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising: determining, from received panel data, a variable to uniquely identify records along a cross-sectional dimension in the panel data; splitting, based on the variable, the panel data into a train dataset, a test dataset, and a validation dataset; determining, based on the validation dataset, an out-of-time period and removing, from the validation dataset, data falling within the out-of-time period; removing, from the train dataset, data falling within the out-of-time period; determining, based on the validation dataset, one or more time intervals and removing, from the validation dataset, data falling outside of the one or more time intervals, wherein the validation dataset includes data that is out-of-sample and out-of-time with respect to the train dataset; removing, from the train dataset, data falling within the one or more time intervals, wherein the train dataset includes data that is out-of-sample and out-of-time with respect to the validation dataset; training a machine learning model based on the train dataset, validating the machine learning model on the validation dataset, and testing the machine learning model on the test dataset, wherein the validation dataset is used to generate an estimate of model error that is out-of-sample and out-of-time with respect to the train dataset; and generating, using the machine learning model, an output based on new input.

2. A method, comprising: splitting received panel data into a train dataset, a test dataset, and a validation dataset; determining, based on the validation dataset, an out-of-time period and removing, from the validation dataset, data falling within the out-of-time period; removing, from the train dataset, data falling within the out-of-time period; determining, based on the validation dataset, one or more time intervals and removing, from the validation dataset, data falling outside of the one or more time intervals, wherein the validation dataset includes data that is out-of-sample and out-of-time with respect to the train dataset; removing, from the train dataset, data falling within the one or more time intervals, wherein the train dataset includes data that is out-of-sample and out-of-time with respect to the validation dataset; and training a first machine learning model based on the train dataset, validating the first machine learning model on the validation dataset, and testing the first machine learning model on the test dataset.

3. A method, comprising: splitting received panel data into a train dataset, a test dataset, and a validation dataset; determining an out-of-time period and removing, from the validation dataset, data falling within the out-of-time period; removing, from the train dataset, data falling within the out-of-time period; determining one or more time intervals and removing, from the validation dataset, data falling outside of the one or more time intervals; and removing, from the train dataset, data falling within the one or more time intervals.

4. The method of any one of the preceding embodiments, further comprising: determining a performance metric for the first machine learning model for the out-of-time period based on the test dataset; in response to determining whether the performance metric is below a threshold, determining updated one or more time intervals; and removing from the train dataset and the validation dataset, data falling within the updated one or more time intervals.

5. The method of any one of the preceding embodiments, further comprising: generating the threshold based on the performance metric of the first machine learning model on the validation dataset.

6. The method of any one of the preceding embodiments, further comprising: determining a performance metric for the first machine learning model; and in response to determining whether the performance metric is below a threshold, modifying a set of hyperparameters of the first machine learning model.

7. The method of any one of the preceding embodiments, further comprising: receiving new panel data and determining a new variable to uniquely identify records along a cross-sectional dimension in the new panel data; splitting, based on the new variable, the new panel data into a new train dataset, a new test dataset, and a new validation dataset; determining, based on the new validation dataset, an out-of-time period and removing, from the new validation dataset, data falling within the out-of-time period; removing, from the train dataset, data falling within the out-of-time period; determining, based on the new validation dataset, one or more time intervals and removing, from the new validation dataset, data falling outside of the one or more time intervals, wherein the new validation dataset includes data that is out-of-sample and out-of-time with respect to the new train dataset; removing, from the new train dataset, data falling within the one or more time intervals, wherein the new train dataset includes data that is out-of-sample and out-of-time with respect to the new validation dataset; and training a second machine learning model based on the new train dataset select model based on validation dataset and test model performance on test dataset.

8. The method of any one of the preceding embodiments, wherein splitting the panel data into a train dataset, a test dataset, and a validation dataset further comprises preprocessing the panel data to remove any instances of incomplete data.

9. The method of any one of the preceding embodiments, wherein splitting the panel data into a train dataset, a test dataset, and a validation dataset further comprises: determining, from received panel data, a variable to uniquely identify records along a cross-sectional dimension in the panel data; and determining, based on the received panel data, a size for the train dataset, test dataset, and validation dataset, wherein the size corresponds to a time period of the panel data.

10. The method of any one of the preceding embodiments, further comprising: comparing the first machine learning model to the second machine learning model based on performance metrics to determine which machine learning model performs better; and in response to determining that the second machine learning model outperforms the first machine learning model, averaging outputs from the first machine learning model and the second machine learning model to generate a new output.

11. The method of any one of the preceding embodiments, further comprising in response to determining that the performance metric is below the threshold, determining a new size for the train dataset, the test dataset, and the validation dataset, wherein the new size corresponds to a larger time period of the panel data compared to a previous size.

12. The method of any one of the preceding embodiments, wherein the test dataset is used to generate an estimate of model error that is out-of-sample and out-of-time with respect to the validation dataset and the train dataset.

13. One or more non-transitory, computer-readable media storing instructions that, when executed by a data processing apparatus, cause the data processing apparatus to perform operations comprising those of any of embodiments 1-12.

14. A system comprising one or more processors; and memory storing instructions that, when executed by the processors, cause the processors to effectuate operations comprising those of any of embodiments 1-12.

15. A system comprising means for performing any of embodiments 1-12.

What is claimed is:

1. A system for generating machine learning models based on panel data that is split along cross-sectional and time dimensions, comprising:
one or more processors; and
one or more non-transitory computer-readable media storing instructions that when executed by the one or more processors cause operations comprising:
determining, from received panel data, a variable to uniquely identify records along a cross-sectional dimension in the panel data;
splitting, based on the variable, the panel data into a train dataset, a test dataset, and a validation dataset;
determining, based on the validation dataset, an out-of-time period and removing, from the validation dataset, data falling within the out-of-time period;
removing, from the train dataset, data falling within the out-of-time period;
determining, based on the validation dataset, one or more time intervals and removing, from the validation dataset, data falling outside of the one or more time intervals, wherein the validation dataset includes data that is out-of-sample and out-of-time with respect to the train dataset;
removing, from the train dataset, data falling within the one or more time intervals, wherein the train dataset includes data that is out-of-sample and out-of-time with respect to the validation dataset;
training a machine learning model based on the train dataset, validating the machine learning model on the validation dataset, and testing the machine learning model on the test dataset, wherein the validation dataset is used to generate an estimate of model error that is out-of-sample and out-of-time with respect to the train dataset; and
generating, using the machine learning model, an output based on new input.

2. A method for generating machine learning models based on panel data that is split along cross-sectional and time dimensions, the method comprising:
splitting received panel data into a train dataset, a test dataset, and a validation dataset;
determining, based on the validation dataset, an out-of-time period and removing, from the validation dataset, data falling within the out-of-time period;
removing, from the train dataset, data falling within the out-of-time period;
determining, based on the validation dataset, one or more time intervals and removing, from the validation dataset, data falling outside of the one or more time intervals, wherein the validation dataset includes data that is out-of-sample and out-of-time with respect to the train dataset;
removing, from the train dataset, data falling within the one or more time intervals, wherein the train dataset includes data that is out-of-sample and out-of-time with respect to the validation dataset; and
training a first machine learning model based on the train dataset, validating the first machine learning model on the validation dataset, and testing the first machine learning model on the test dataset.

3. The method of claim 2, further comprising:
determining a performance metric for the first machine learning model for the out-of-time period based on the test dataset;
in response to determining whether the performance metric is below a threshold, determining updated one or more time intervals; and
removing from the train dataset and the validation dataset falling within the updated one or more time intervals.

4. The method of claim 3, further comprising generating the threshold based on the performance metric of the first machine learning model on the validation dataset.

5. The method of claim 2, further comprising:
determining a performance metric for the first machine learning model; and
in response to determining whether the performance metric is below a threshold, modifying a set of hyperparameters of the first machine learning model.

6. The method of claim 2, further comprising:
receiving new panel data and determining a new variable to uniquely identify records along a cross-sectional dimension in the new panel data;
splitting, based on the new variable, the new panel data into a new train dataset, a new test dataset, and a new validation dataset;
determining, based on the new validation dataset, an out-of-time period and removing, from the new validation dataset, data falling within the out-of-time period;
removing, from the train dataset, data falling within the out-of-time period;
determining, based on the new validation dataset, one or more time intervals and removing, from the new validation dataset, data falling outside of the one or more time intervals, wherein the new validation dataset includes data that is out-of-sample and out-of-time with respect to the new train dataset;
removing, from the new train dataset, data falling within the one or more time intervals, wherein the new train dataset includes data that is out-of-sample and out-of-time with respect to the new validation dataset; and
training a second machine learning model based on the new train dataset.

7. The method of claim 2, wherein splitting the panel data into a train dataset, a test dataset, and a validation dataset further comprises preprocessing the panel data to remove any instances of incomplete data.

8. The method of claim 2, wherein splitting the panel data into a train dataset, a test dataset, and a validation dataset further comprises:
determining, from received panel data, a variable to uniquely identify records along a cross-sectional dimension in the panel data; and
determining, based on the received panel data, a size for the train dataset, test dataset, and validation dataset, wherein the size corresponds to a time period of the panel data.

9. The method of claim 6, further comprising:
comparing the first machine learning model to the second machine learning model based on performance metrics to determine which machine learning model performs better; and
in response to determining that the second machine learning model outperforms the first machine learning model, averaging outputs from the first machine learning model and the second machine learning model to generate a new output.

10. The method of claim 5, further comprising in response to determining that the performance metric is below the threshold, determining a new size for the train dataset, the test dataset, and the validation dataset, wherein the new size corresponds to a larger time period of the panel data compared to a previous size.

11. The method of claim 2, wherein the test dataset is used to generate an estimate of model error that is out-of-sample and out-of-time with respect to the validation dataset and the train dataset.

12. One or more non-transitory, computer-readable media storing instructions that, when executed by one or more processors, cause operations comprising:
splitting received panel data into a train dataset, a test dataset, and a validation dataset;
determining an out-of-time period and removing, from the validation dataset, data falling within the out-of-time period;
removing, from the train dataset, data falling within the out-of-time period;
determining one or more time intervals and removing, from the validation dataset, data falling outside of the one or more time intervals; and
removing, from the train dataset, data falling within the one or more time intervals.

13. The one or more non-transitory, computer-readable media of claim 12, wherein the instructions further cause the one or more processors to perform operations comprising:
determining a performance metric for a first machine learning model for the out-of-time period based on the test dataset;
in response to determining whether the performance metric is below a threshold, determining updated one or more time intervals; and
removing from the train dataset and the validation dataset falling within the updated one or more time intervals.

14. The one or more non-transitory, computer-readable media of claim 13, wherein the instructions further cause the one or more processors to perform operations comprising generating the threshold based on the performance metric of the first machine learning model on the validation dataset.

15. The one or more non-transitory, computer-readable media of claim 12, wherein the instructions further cause the one or more processors to perform operations comprising:
determining a performance metric for a first machine learning model; and
in response to determining whether the performance metric is below a threshold, modifying a set of hyperparameters of the first machine learning model.

16. The one or more non-transitory, computer-readable media of claim 12, wherein the instructions further cause the one or more processors to perform operations comprising:
receiving new panel data and determining a new variable to uniquely identify records along a cross-sectional dimension in the new panel data;
splitting, based on the new variable, the new panel data into a new train dataset, a new test dataset, and a new validation dataset;
determining, based on the new validation dataset, an out-of-time period and removing, from the new validation dataset, data falling within the out-of-time period;
removing, from the train dataset, data falling within the out-of-time period;
determining, based on the new validation dataset, one or more time intervals and removing, from the new validation dataset, data falling outside of the one or more time intervals, wherein the new validation dataset includes data that is out-of-sample and out-of-time with respect to the new train dataset;
removing, from the new train dataset, data falling within the one or more time intervals, wherein the new train dataset includes data that is out-of-sample and out-of-time with respect to the new validation dataset; and
training a second machine learning model based on the new train dataset.

17. The one or more non-transitory, computer-readable media of claim 12, wherein splitting the received panel data into a train dataset, a test dataset, and a validation dataset further comprises preprocessing the received panel data to remove any instances of incomplete data.

18. The one or more non-transitory, computer-readable media of claim 12, wherein splitting the received panel data into a train dataset, a test dataset, and a validation dataset further comprises:
determining, from received panel data, a variable to uniquely identify records along a cross-sectional dimension in the received panel data; and
determining, based on the received panel data, a size for the train dataset, test dataset, and validation dataset, wherein the size corresponds to a time period of the received panel data.

19. The one or more non-transitory, computer-readable media of claim 12, wherein the test dataset is used to generate an estimate of model error that is out-of-sample and out-of-time with respect to the validation dataset and the train dataset.

20. The one or more non-transitory, computer-readable media of claim 16, wherein the instructions further cause the one or more processors to perform operations comprising:
comparing a first machine learning model to the second machine learning model based on performance metrics to determine which machine learning model performs better; and
in response to determining that the second machine learning model outperforms the first machine learning model, averaging outputs from the first machine learning model and the second machine learning model to generate a new output.
